(19) United States
(12) Patent Application Publication
(10) Pub. No.: US 2026/0350724 A1
(43) Pub. Date: Nov. 5, 2026

(54) SYSTEM AND METHOD FOR IMPROVING LEGAL QUESTION ANSWERING THROUGH STRUCTURED KNOWLEDGE REPRESENTATION

(71) Applicant: Thomson Reuters Enterprise Centre GmbH, Zug (CH)

(72) Inventors: Frank Schilder, St. Paul, MN (US); Ankita Gupta, Natick, MA (US)

(21) Appl. No.: 19/648,590

(22) Filed: Apr. 15, 2026

Related U.S. Application Data
(60) Provisional application No. 63/799,043, filed on May 2, 2025.

(51) Int. Cl. G06Q 50/18

(52) U.S. Cl. CPC G06Q 50/18

(57) ABSTRACT

A system for automated document analysis is provided, comprising: a computing platform including a processor; a memory including instructions that when executed by the processor cause the computing platform to: retrieve an input document; provide the input document to an artificial intelligence (“AI”) model of the computing platform; extract, using the AI model, triples from the input document in an entity-relation-argument form; provide, by a prompting module of the computing platform, to the AI model a question including at least one of an argument for analysis, a bar question or a legal reasoning task; and generate a response to the question by identifying, using the AI model and the extracted triples, whether the question is supported by the input document.

### RELATED APPLICATIONS

This application is related to and claims priority to provisional application Ser. 63/799,043, entitled “IMPROVING LEGAL QUESTION ANSWERING THROUGH STRUCTURED KNOWLEDGE REPRESENTATION,” filed on May 2, 2025, the entire contents of which being expressly incorporated herein by reference.

### FIELD

The present disclosure pertains to document analysis and more specifically to legal question answering by large language models (“LLMs”) executing an intermediate triples extraction step.

### BACKGROUND

Legal professionals worldwide are increasingly enthusiastic about integrating LLMs into their workflows to enhance legal services while reducing costs. Such artificial intelligence (“AI”) tools are already being deployed across various aspects of legal practice, including providing jurisdiction-specific legal information, spotting potential issues in cases, creating legal documents, and numerous other applications.

However, legal texts present unique challenges for automated processing due to their complex sentence structures often with multiple subclauses embedded within a single sentence. These texts are also fact-intensive and interleaved with specialized legal terminology, making their comprehension difficult. For instance, prior work has observed limitations in the ability of LLMs to distinguish between arguments made by different legal actors. These comprehension difficulties can significantly impact downstream task performance. For example, answering legal questions based on a relevant legal text requires the LLM to carefully understand and reason about laws and precedence cases mentioned in the legal text and apply them to answer the specific question. The challenge intensifies in real-world scenarios where relevant passages must first be retrieved from extensive legal corpora, as in a Retrieval Augmented Generation (“RAG”) pipeline. In such cases, imperfect retrieval mechanisms can introduce noisy or only partially relevant passages, further complicating the question answering process. Accordingly, it would be desirable to provide an automated document analysis system and method that addresses the shortcomings of conventional approaches.

### SUMMARY

In one embodiment, the present disclosure provides a method of automated document analysis, comprising: retrieving, by a computing platform, an input document; providing, by the computing platform, the input document to an artificial intelligence (“AI”) model; extracting, using the AI model, triples from the input document in an entity-relation-argument form; providing, by a prompting module of the computing platform, to the AI model a question including at least one of an argument for analysis, a bar question or a legal reasoning task; and generating a response to the question by identifying, using the AI model and the extracted triples, whether the question is supported by the input document. One aspect of this embodiment further comprises displaying a human-interpretable representation of the response on a display of the computing platform. In another aspect, the entity of the triples represents a legal actor making a statement in the input document. In a variant of this aspect, the argument of the triples represents information expressed by the legal actor in the input document. In a further variant, the relation of the triples represents whether the legal actor supports or contradicts the information in the input document. In another aspect, extracting, using the AI model, triples from the input document includes directly prompting, by the prompting module, the AI model to extract triples from the input document without using a knowledge graph. In yet another aspect of this embodiment, retrieving, by the computing platform, the input document includes accessing a legal corpora including the input document.

In another embodiment, the present disclosure provides a system for automated document analysis, comprising: a computing platform including a processor; a memory including instructions that when executed by the processor cause the computing platform to: retrieve an input document; provide the input document to an artificial intelligence (“AI”) model of the computing platform; extract, using the AI model, triples from the input document in an entity-relation-argument form; provide, by a prompting module of the computing platform, to the AI model a question including at least one of an argument for analysis, a bar question or a legal reasoning task; and generate a response to the question by identifying, using the AI model and the extracted triples, whether the question is supported by the input document. In one aspect of this embodiment, execution of the instructions by the processor further causes the computing platform to display a human-interpretable representation of the response on a display of the computing platform. In another aspect, the entity of the triples represents a legal actor making a statement in the input document. In a variation of this aspect, the argument of the triples represents information expressed by the legal actor in the input document. In a further variation, the relation of the triples represents whether the legal actor supports or contradicts the information in the input document. In another aspect of this embodiment, extracting, using the AI model, triples from the input document includes directly prompting, by the prompting module, the AI model to extract triples from the input document without using a knowledge graph. In another aspect, retrieving, by the computing platform, the input document includes accessing a legal corpora including the input document.

In yet another embodiment, the present disclosure provides a computer program product, stored on a non-transitory computer readable medium, comprising instructions that when executed by one or more processors of a computing platform cause the computing platform to: retrieve an input document; provide the input document to an artificial intelligence (“AI”) model of the computing platform; extract, using the AI model, triples from the input document in an entity-relation-argument form; provide, by a prompting module of the computing platform, to the AI model a question including at least one of an argument for analysis, a bar question or a legal reasoning task; and generate a response to the question by identifying, using the AI model and the extracted triples, whether the question is supported by the input document. In one aspect of this embodiment, execution of the instructions by the one or more processors further causes the computing platform to display a human-interpretable representation of the response on a display of the computing platform. In another aspect, the entity of the triples represents a legal actor making a statement in the input document, the argument of the triples represents information expressed by the legal actor in the input document and the relation of the triples represents whether the legal actor supports or contradicts the information in the input document. In yet another aspect, extracting, using the AI model, triples from the input document includes directly prompting, by the prompting module, the AI model to extract triples from the input document without using a knowledge graph. In another aspect of this embodiment, retrieving, by the computing platform, the input document includes accessing a legal corpora including the input document.

### BRIEF DESCRIPTION OF THE DRAWINGS

The above-mentioned and other advantages and objects of this invention, and the manner of attaining them, will become more apparent, and the invention itself will be better understood, by reference to the following description of embodiments of the invention taken in conjunction with the accompanying drawings, wherein:

FIG. 1 is a conceptual diagram of an automated document analysis system according to one embodiment of the present disclosure;

FIG. 2 is a conceptual diagram of a legal text and triples extracted from the legal text;

FIG. 3 is a graph depicting varying weighted-average F1 scores of an example LLM with and without triple generation given different numbers of distractor passages; and

FIG. 4 is a flow chart depicting a method of automated document analysis according to one embodiment of the present disclosure.

### DETAILED DESCRIPTION

The present disclosure provides systems and methods for structuring the knowledge present in legal text to improve the LLMs ability to answer legal questions. In general, prior to requesting an LLM to answer a question, the LLM is prompted to generate triples of the form entity-relation-argument from the given legal text(s). The term “entity” as used herein refers to a legal actor making a statement in the text (e.g., litigants, judges, cited precedents, statutes, etc.). The term “argument” as used herein is the information that is expressed by the entity in the legal text(s). The term “relation” as used herein is how the information is expressed (i.e., whether the entity supports or contradicts the information). After extracting these triples, the LLM is prompted to answer the question using the triples as structured knowledge representation of the legal text(s).

As described below, the approach described herein improves the performance of small language models, such as Qwen-3-8B and Llama-3-8B, in two different settings: 1) when the query-relevant passage is available; and 2) when the relevant passage is not known and has to be retrieved from a given legal corpora. This may reduce misattributions in LLM generated answers and improve legal reasoning more broadly.

The term “knowledge representation” refers to various formats that encode structured meaning representations in the form of pre-defined schemata representing entities and properties of these entities. Conventionally, the knowledge is often encoded via entity-relation-entity triples (e.g., capital(France, Paris)) extracted from plain texts or manually curated, which are used to construct knowledge graphs or databases with special data formats or schemata. The approach described below, however, focuses on triples of the form entity-relation-argument, extracting arguments supported by the entities as mentioned within legal texts, thus extending the prior approaches beyond entity-level relations. Moreover, a system and/or method according to the present disclosure instructs the model to create triplets at the time of prompting and hence do not rely on a knowledge graph (“KG”) that has to be pre-generated and/or curated.

As is known in the art, KGs are graph-structured knowledge bases that integrate entities and relations from diverse data sources into a unified schema. They typically employ Semantic Web standards (e.g., RDF, OWL) and ontologies to model concepts and relationships, enabling rich semantic queries (e.g., SPARQL) and both deductive and inductive reasoning. However, typical KGs require pre-defined schemata and it is impossible to anticipate every type of relation and property encountered in a lawsuit. Also, they are difficult to maintain and may be too rigid for legal reasoning use cases.

Legal KGs are specialized, structured databases that organize legal information into a network of entities and their relationships. Legal KGs aim to structure case law, statutes, regulations, and related documents into a semantic network. Nodes represent legal entities (courts, judges, cases, laws, legal concepts) and edges capture relations like citations, amendments, or topic hierarchies. Legal KGs often build on domain-specific ontologies (e.g., LKIF Core,1 LegalRuleML2) to model norms, actions, and agents. Similar to general purpose KGs, however, they tend to be cumbersome to maintain even though recent work has shown utility of combining KG modeling Chinese criminal statutes and historical cases to achieve higher law-article recommendation accuracy.

Structured data (e.g., graphs, tables, schemata) are increasingly used to guide LLMs, especially in domains like law that demand precise reasoning. Motivated by Chain-of-Thought (CoT) approaches, some approaches have used more structured data injected in the prompts and showed improvements for complex problems that require multi-step reasoning. For example, frameworks such as StructGPT leverage structured inputs by interleaving “reading” and “reasoning” phases: the system first queries a KG or table to collect evidence, then prompts the LLM to reason over that evidence. For example, a prompt-reformulation system tied to a legal KG may be designed wherein the KG is queried to generate precise legal citations for issues raised by the LLM's output, enriching and correcting the response but not modeling the attribution of different statements to the respective legal actors.

In contrast to past approaches in this area, the system and method of the present disclosure prompts the LLM directly to produce the respective triplet structure of legal agents and arguments, not requiring well-defined KGs of legal concepts.

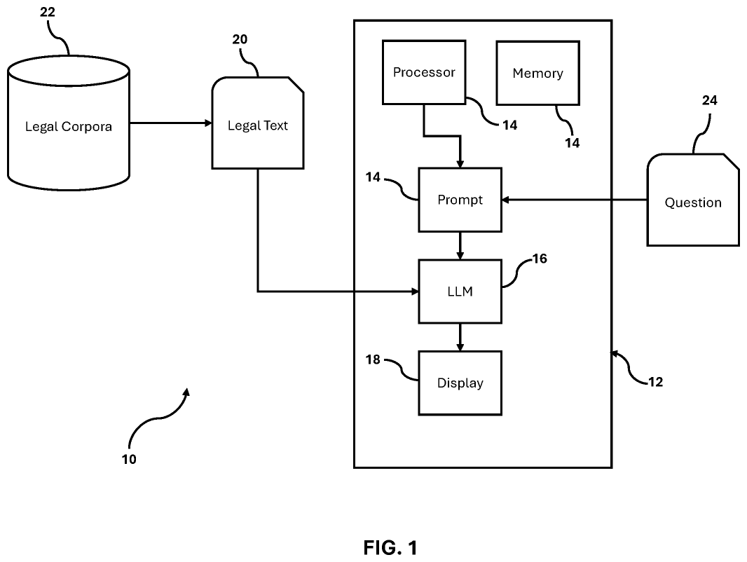

A representation of a system 10 for automated document analysis according to one embodiment of the present disclosure is shown in FIG. 1. In general, the system 10 includes a computing platform 12 with a processor 13, a prompting module 14, a memory 15, an LLM 16 and a display 18. In one embodiment, the processor 13 accesses the memory 15 to execute instructions stored in the memory 15 to cause the processor to perform the functions described herein. In one embodiment, the processor 13 causes the LLM 16 to retrieve a legal text 20 from a legal corpora 22. As described herein, the processor 13 causes the prompting module 14 to prompt the LLM 16 to extract triples from the legal text 20. The processor 13 then causes the prompting module 14 to retrieve a question 24 and prompt the LLM 16 to answer the question 24 using the extracted triples from the legal text 20. The LLM 16 formulates an answer and provides a human-interpretable response to the display 18 of the computing platform 12.

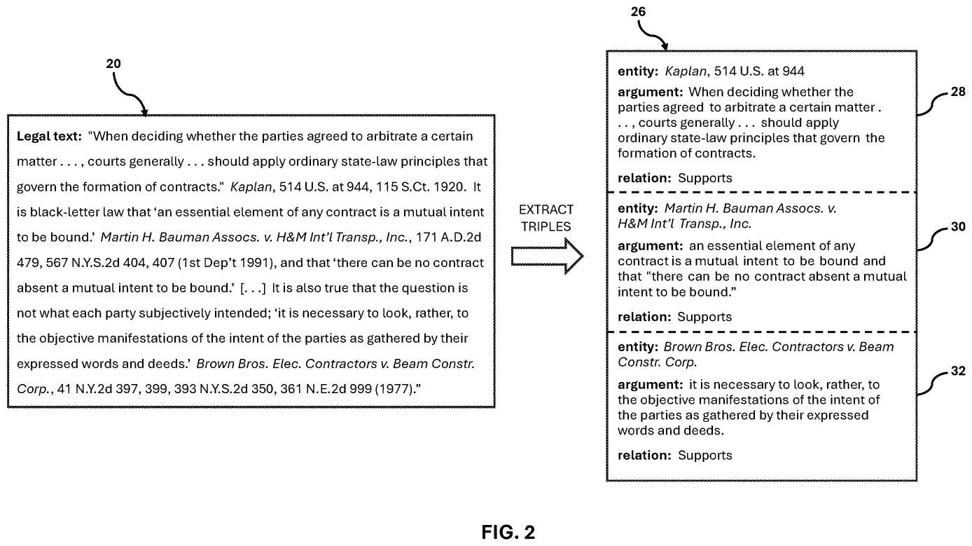

Referring now to FIG. 2 for a description of triples generation. Triples are extracted from legal text(s) 20 that have been either provided as input by the prompting module 14 or has been retrieved from the legal corpora 22 to answer the question 24. The LLM 16 is prompted to generate triples of the form entity-relation-argument from the given legal text(s) 20. As indicated above, an entity refers to a legal actor making a statement in the legal text(s) 20 (e.g., litigants, judges, precedents, statutes). An argument is the information that is expressed by the entity in the legal text(s) 20. An argument can be a clause within a sentence, complete sentences or even multiple sentences, based on the amount of information provided by the legal actor in the legal text(s) 20. Finally, the relation describes how the argument is expressed by the entity (i.e., whether the entity supports or contradicts the argument). An example legal text 20 along with extracted triples 26 is shown in FIG. 2. As shown, the LLM 16 has extracted three triples 28, 30 and 32 from the legal text 20.

After extracting the triples 26 from given legal text(s) 20, the LLM is further prompted by the prompting module 14 of the computing platform 12 to answer the question 24 based on these triples 26. Allowing the LLM 16 to represent the legal text 20 in a structured knowledge representation format may improve its ability to comprehend and reason over it.

In one example of the approach of the present disclosure, small open-source LLMs including Llama-3.1-8B-Instruct and Qwen-3-8B were considered. These LLMs are particularly valuable as they can be downloaded locally and help alleviate privacy concerns. However, off-the-shelf performance of such LLMs is often not at par with their larger counterparts, necessitating development of methods to improve their performance.

In this example, the Bar Exam QA datasets were evaluated. The Bar Exam QA dataset is a dataset of questions from the multistate bar exam (“MBE”), which certifies law students to practice law in the U.S. Each example in this dataset contains a legal scenario, a question about a specific legal issue implicated in the scenario, a gold passage mentioning laws that can help answer the question and four answer choices. The task is to select the correct answer choice. The test split of the Bar Exam QA dataset was used in the example. As an evaluation metric, the weighted-average F1 scores, calculated over option choices, were used for both datasets. A weighted-average F1 score is a performance metric used in machine learning to evaluate classification models, particularly on imbalanced datasets. It calculates the F1 score for each individual class and then averages them together, weighting each class's score by its support (the number of actual instances of that class in the dataset). The weighted-average F1 score may be represented by the following equation:

Weighted F1=Σ(F1×Supporti)÷Total Samples

In one example, the gold passage relevant to the query is given. This is a simpler setting for determining the performance of the approach of the present disclosure, where the legal text 20 that can help answer the query is already known. Thus, as part of the input, the LLM 16 is provided with the relevant legal passage and the question 24. In another example, the gold passage relevant to the query is not given. This represents a more realistic setting, when the passages useful for answering the legal question 24 are not already known and must be retrieved from the large legal corpora 22, similar to a Retrieval-Augmented Generation (“RAG”) setting. In this example, such a setting was simulated using a simulated retriever, which provides the LLM 16 with input containing the gold passage, distractor passages (i.e., passages intended to simulate imperfect retrieval) and the legal question 24. The gold passages and the distractor passages were ordered randomly.

The results set out in Table 1 below demonstrate that that triple generation improves performance.

TABLE 1

| DATASET | MODELS | W/TRIPLES | W/O TRIPLES |
|---|---|---|---|
| Bar Exam QA | Llama-3.1-8B-Instruct | 0.64 | 0.59 |
| Bar Exam QA | Qwen-3-8B (no think) | 0.54 | 0.56 |
| Bar Exam QA | Qwen-3-8B (think) | 0.57 | 0.54 |

The results in Table 1 show the performance of the different models when prompted to answer the question 24 with and without an intermediate triple generation step. As shown, both the Llama-3.1-8B-Instruct model and the Qwen-3-8B model in the think setting benefit from the intermediate triple generation step. As should be apparent from the data, the Qwen-3-8B model in the no think setting does not benefit from intermediate triple generation. This result is possible as the Qwen-3-8B model is specialized for answering simple questions and is not able to utilize the generated triples in its reasoning. Furthermore, this model often directly answers the question, ignoring the instruction to generate triples, and thus obtains lower performance compared to setting without triples. As such, this model is not able to incorporate new triple information into its reasoning. Instead, it follows its own CoT-style reasoning and possibly overfits to the type of problems it has been trained on (e.g., solving math or logic puzzles). Similar trends may be observed with state-of-the-art reasoning models, such as deep-seek-32B, which always ignores the triple generation instruction and generates its own reasoning to answer the question.

As another example, the performance of LLMs 16 was analyzed with varying numbers of distractor passages in the RAG setting. Also, the performance of the LLMs 16 was analyzed when the gold passage is not given in advance and must be retrieved from the legal corpora 22. This setting was simulated by providing the gold passage and varying the number of distractor passages provided as input to the LLM 16. The Llama-3.1-8B-Instruct model performance was also tested with and without the triple generation step.

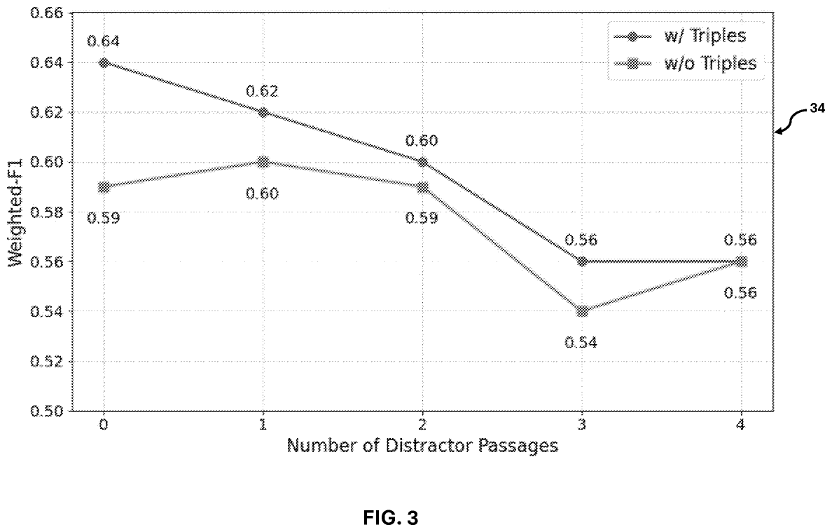

As shown by the graph 34 in FIG. 3, the intermediate triple generation consistently helps achieve better performance compared to the setting without intermediate triple generation. When the number of distractor passages input into the LLM 16 is increased, the performance generally declines in both settings (i.e., with and without intermediate triple generation) as more noise in the input affects the LLM's 16 performance. However, the triple generation method maintains its advantage across the different distractor passage levels.

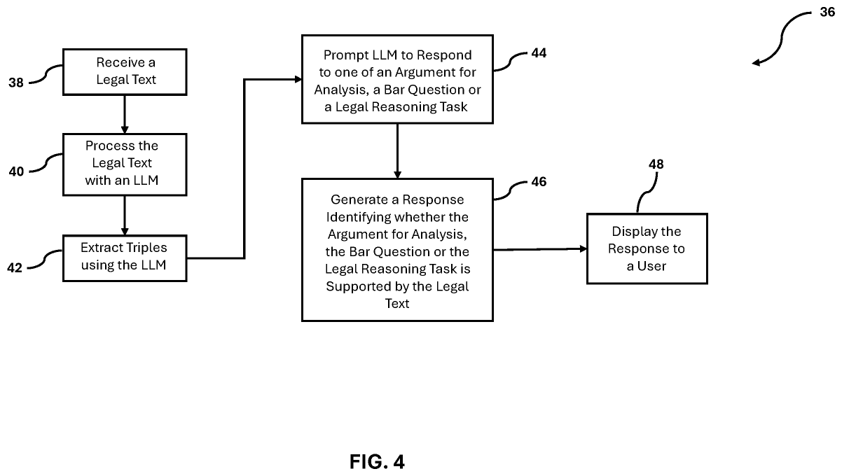

Referring now to FIG. 4, a method 36 for automated document analysis according to one embodiment of the present disclosure is shown. The method 36 begins at step 38 with the processor 13 of the computing platform 12 receiving an input document or legal text 20. At step 40, the computing platform 12 processes the legal text 20 with an AI model or LLM 16. At step 42, the LLM 16 is used to extract triples 26 from the legal text 20. As indicated above, each of the extracted triples 26 are of the entity-relation-argument form. At step 44, the LLM 16 is prompted by the computing platform 12 to respond to at least one of an argument for analysis, a bar question or a legal reasoning task (collectively referred to as a question 24). At step 46, the LLM 16 generates a response by identifying, using the extracted triples 26, whether the at least one of the argument for analysis, the bar question or the legal reasoning task is supported by the legal text 24. Finally, at step 48 the response is displayed on the display 18 for review by a user.

As should be apparent from the foregoing, structuring legal knowledge through entity-relation-argument triples significantly enhances the performance of LLMs 16 on legal question answering tasks. By first decomposing complex legal texts 20 into these structured representations before answering questions 24, LLMs 16 such as Qwen-3-8B and Llama-3.1-8B can better navigate the inherent challenges of legal language. The effectiveness this approach across both controlled settings (i.e., with gold passage given) and more realistic retrieval setting highlights its robustness and practical utility. This structured knowledge extraction serves as an effective intermediary step that helps LLMs 16 systematically process the complex relationships between legal actors, their arguments, and the underlying legal principles.

It should be understood that the principles of the present disclosure may be applied to other legal tasks such as contract analysis, compliance verification, and legal document drafting. Also, one of ordinary skill in the art will realize that the embodiments provided can be implemented in hardware, software, firmware, and/or a combination thereof. For example, the computing platform 12 disclosed herein may form a portion of a processing subsystem including one or more computing devices having memory, processing, and communication hardware. The controllers may be a single device or a distributed device, and the functions of the controllers may be performed by hardware and/or as computer instructions on a non-transient computer readable storage medium. For example, the computer instructions or programming code in the controller may be implemented in any viable programming language such as C, C++, C#, python, JAVA or any other viable high-level programming language, or a combination of a high-level programming language and a lower level programming language.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A method of automated document analysis, comprising:
retrieving, by a computing platform, an input document;
providing, by the computing platform, the input document to an artificial intelligence (“AI”) model;
extracting, using the AI model, triples from the input document in an entity-relation-argument form;
providing, by a prompting module of the computing platform, to the AI model a question including at least one of an argument for analysis, a bar question or a legal reasoning task; and
generating a response to the question by identifying, using the AI model and the extracted triples, whether the question is supported by the input document.

2. The method of claim 1, further comprising displaying a human-interpretable representation of the response on a display of the computing platform.

3. The method of claim 1, wherein the entity of the triples represents a legal actor making a statement in the input document.

4. The method of claim 3, wherein the argument of the triples represents information expressed by the legal actor in the input document.

5. The method of claim 4, wherein the relation of the triples represents whether the legal actor supports or contradicts the information in the input document.

6. The method of claim 1, wherein extracting, using the AI model, triples from the input document includes directly prompting, by the prompting module, the AI model to extract triples from the input document without using a knowledge graph.

7. The method of claim 1, wherein retrieving, by the computing platform, the input document includes accessing a legal corpora including the input document.

8. A system for automated document analysis, comprising:
a computing platform including a processor;
a memory including instructions that when executed by the processor cause the computing platform to:
retrieve an input document;
provide the input document to an artificial intelligence (“AI”) model of the computing platform;
extract, using the AI model, triples from the input document in an entity-relation-argument form;
provide, by a prompting module of the computing platform, to the AI model a question including at least one of an argument for analysis, a bar question or a legal reasoning task; and
generate a response to the question by identifying, using the AI model and the extracted triples, whether the question is supported by the input document.

9. The system of claim 8, wherein execution of the instructions by the processor further causes the computing platform to display a human-interpretable representation of the response on a display of the computing platform.

10. The system of claim 8, wherein the entity of the triples represents a legal actor making a statement in the input document.

11. The system of claim 10, wherein the argument of the triples represents information expressed by the legal actor in the input document.

12. The system of claim 11, wherein the relation of the triples represents whether the legal actor supports or contradicts the information in the input document.

13. The system of claim 8, wherein extracting, using the AI model, triples from the input document includes directly prompting, by the prompting module, the AI model to extract triples from the input document without using a knowledge graph.

14. The system of claim 8, wherein retrieving, by the computing platform, the input document includes accessing a legal corpora including the input document.

15. A computer program product, stored on a non-transitory computer readable medium, comprising instructions that when executed by one or more processors of a computing platform cause the computing platform to:
retrieve an input document;
provide the input document to an artificial intelligence (“AI”) model of the computing platform;
extract, using the AI model, triples from the input document in an entity-relation-argument form;
provide, by a prompting module of the computing platform, to the AI model a question including at least one of an argument for analysis, a bar question or a legal reasoning task; and
generate a response to the question by identifying, using the AI model and the extracted triples, whether the question is supported by the input document.

16. The computer program product of claim 15, wherein execution of the instructions by the one or more processors further causes the computing platform to display a human-interpretable representation of the response on a display of the computing platform.

17. The computer program product of claim 15, wherein the entity of the triples represents a legal actor making a statement in the input document, the argument of the triples represents information expressed by the legal actor in the input document and the relation of the triples represents whether the legal actor supports or contradicts the information in the input document.

18. The computer program product of claim 15, wherein extracting, using the AI model, triples from the input document includes directly prompting, by the prompting module, the AI model to extract triples from the input document without using a knowledge graph.

19. The computer program product of claim 15, wherein retrieving, by the computing platform, the input document includes accessing a legal corpora including the input document.
